(19) United States
(12) Patent Application Publication
(10) Pub. No.: US 2004/0007141 A1
(43) Pub. Date: Jan. 15, 2004

(54) Press, particularly a press with a high pressure force

(75) Inventor: Juergen Fahrenbach, Aichelberg (DE)

Correspondence Address: CROWELL & MORING LLP, INTELLECTUAL PROPERTY GROUP, P.O. BOX 14300, WASHINGTON, DC, 20044-4300, US

(73) Assignee: Schuler Pressen GmbH & Co. KG.

(21) Appl. No.: 10/614,988

(22) Filed: Jul. 9, 2003

(30) Foreign Application Priority Data
Jul. 9, 2002 (DE) 102 31 031.9

(51) Int. Cl. B30B 1/02

(52) U.S. Cl. 100/285

(57) ABSTRACT

Arrangement of several presses having in each case at least one flywheel and in each case at least one shaft drive acting upon a shaft. The at least one shaft drive of each press, respectively, and its at least one flywheel, respectively, are mutually synchronized.

### BACKGROUND OF THE INVENTION

This application claims the priority of Germany, Application No. 102 31 031.9, filed on Jul. 9, 2002, the disclosures of which are expressly incorporated by reference herein.

The present invention relates to a press, particularly a press with a high pressure force, having at least one flywheel and at least one shaft drive acting upon a shaft.

During a pressing operation, a number of additional functions have to be carried out which are required for the pressing operation. These additional functions, such as the operation of the ejectors, of the transfer devices, of the tongs box, and of the automation, have to be coordinated with the pressing operation with respect to time. So far, high energy has been required for synchronizing freely programmable ejector drives or additional accessory drives with the pressing operation, because each of these drives draws electrical energy from the power supply network simultaneously with the press drive.

As a result of the simultaneous energy withdrawal in the conventional pressing operation, disturbances in the power supply network may occur because of an overloading of the network. In addition, the electrical supply lines are required to have correspondingly large dimensions in order simultaneously to supply the various drives with sufficient energy. Particularly, however, the provision of high energy peaks frequently presents a considerable problem because only a limited amount of energy is available. Shortages may thus occur in the power supply.

### SUMMARY OF THE INVENTION

An object of the present invention is to improve a press of the above-mentioned type in that, in the future, energy supply shortages are prevented even when the press and additional functions are operated simultaneously.

The present invention achieves the aforementioned object with a press, particularly a press with a high pressure force, having at least one flywheel and at least one shaft drive acting upon a shaft, in which the at least one shaft drive and the at least one flywheel are mutually synchronized. As a result of the synchronization of the at least one shaft drive with the at least one flywheel, the at least one flywheel can then supply its energy to an additional device when the energy withdrawal of the at least one shaft drive from the power supply network is maximal during the drawing operation.

Because the energy stored in the flywheel in the present invention can be used for the drive of the additional device, no additional energy from the power supply network has to be made available to the drive of the additional device. Thereby, shortages in the energy supply are avoided when the shaft drive and the additional devices are operated simultaneously. After the deep-drawing operation has been concluded, thus starting from the lower reversal point of the press slide, the energy demand of the wave drive will be minimal. Energy can then be withdrawn from the power supply network, in order to increase the rotational speed of the flywheel again and thus newly charge the energy stored in the flywheel without causing shortages in the energy supply.

Advantageously, the at least one flywheel can be connected by way of the shaft with the additional devices to be driven by the flywheel, such as the ejectors, transfer devices, the tongs box and the automating devices.

In order that, as required, the at least one flywheel can supply the energy stored in it, a coupling may be arranged between the at least one flywheel and the shaft, in order to couple the at least one flywheel to the shaft, or uncouple it from the shaft as soon as the energy stored in the flywheel is no longer needed or has been supplied.

In order to be able to reduce the rotational speed of the main shaft corresponding to the desired synchronization, for example, in the case of several shaft drives to be synchronized, the shaft connected with the shaft drive can be provided with a brake. During the braking of the shaft, this brake can feed the not-required energy back into the power supply network.

Advantageously, the shaft may be a main shaft which may be constructed as a crankshaft.

Independently of the shaft drive, the at least one flywheel can be driven by a separate flywheel drive in order to recharge the energy stored in the flywheel during a time segment when the energy drawn by the press from the power supply network is minimal.

If displaceable masses, which can be displaced between the flywheel center and the flywheel periphery, are arranged in the at least one flywheel, as a result of the displacement of the masses, the rotational speed can be increased or reduced depending on the demand, without the requirement that, in the process, the flywheel is accelerated by the feeding of external energy or is decelerated by the dissipation of energy stored in the flywheel. When the masses are displaced from the flywheel center to the flywheel periphery, the rotational speed of the flywheel will decrease. When the masses are displaced from the flywheel periphery to the flywheel center, the rotational speed of the flywheel will increase.

The flywheel masses can be displaced in a particularly elegant fashion if they are displaced hydraulically and/or pneumatically and/or electrically.

In order to achieve the synchronization between the at least one flywheel and the pressing operation, the press may have a device for monitoring the rotational speed of the flywheel, a device for monitoring the rotational acceleration of the flywheel and a device for the timing.

So as to avoid withdrawal peaks of energy from the power supply network, it is useful for the press to have a device for analyzing the required energy and a device for predicting the required energy. Advantageously, the device for analyzing the required energy and the device for predicting the required energy can be a self-learning unit. This self-learning unit, which advantageously operates according to the fuzzy-logic principle, can detect changes of target definitions and thus establish new target definitions in the future. In this manner, trends can, for example, be recognized in the case of a rotational speed decrease and can be taken into account for the future so that, also in the event of a rotational speed decrease, a synchronization is ensured between the flywheel and the shaft drive of the main shaft.

The press can also be connected with a program for simulating a forming process. This connection of the press with the program for simulating the forming process can be used particularly advantageously in conjunction with the self-learning unit. In the forming program, forming parameters are stored, such as the temperature, characteristic material values, the forming rate, the flowability and the forming force. Thus, the simulation program supplies definitions for the self-learning unit in that it provides the self-learning unit with output values for the start of the pressing operation. By way of the device for analyzing the required energy and the device for predicting the required energy, continuously new forming parameters can be provided to the press which are adapted to the defined conditions of the respective press.

In order to optimally utilize the energy stored in the at least one flywheel with losses which are as low as possible, the press may have a device which supplies a not-required energy quantity from one flywheel to another flywheel and/or feeds it back into the power supply network. For avoiding undesirable unbalanced masses in the at least one flywheel, the at least one flywheel may have a device for compensating an unbalanced mass.

So as to be able to mutually synchronize the at least one shaft drive, respectively, the shafts may also have a device for monitoring the rotational speed. This is particularly significant in the case of eccentric presses with, for example, two crankshafts, so that the upper and the lower tool half are aligned parallel to one another along the tool length and along the tool width. Furthermore, the device for monitoring the rotational speed of the shaft may be required for detecting whether the shaft is synchronized with respect to the entire pressing operation.

In addition, the invention relates to an arrangement of several presses, their at least one shaft drive and their at least one flywheel, respectively, being mutually synchronized. The synchronization according to the invention between the at least one flywheel and the at least one shaft drive thus results in considerable advantages if several presses, through which a workpiece to be machined passes successively, are arranged behind one another. Because the energy withdrawal from the power supply network is particularly high during the operation of several presses simultaneously, the advantages provided by the invention of the synchronization between the at least one flywheel and the at least one shaft drive are particularly significant.

### BRIEF DESCRIPTION OF THE DRAWINGS

Other objects, advantages and novel features of the present invention will become apparent from the following detailed description of the invention when considered in conjunction with the accompanying drawings.

FIG. 1 is a partial cross-sectional view of several driving units which are part of various presses;

FIG. 2 is a schematic perspective view of an eccentric press with two crankshafts; and

FIG. 3 is a graph of a characteristic stroke rate and rotational speed curve which is entered in relation to time.

### DETAILED DESCRIPTION OF THE DRAWINGS

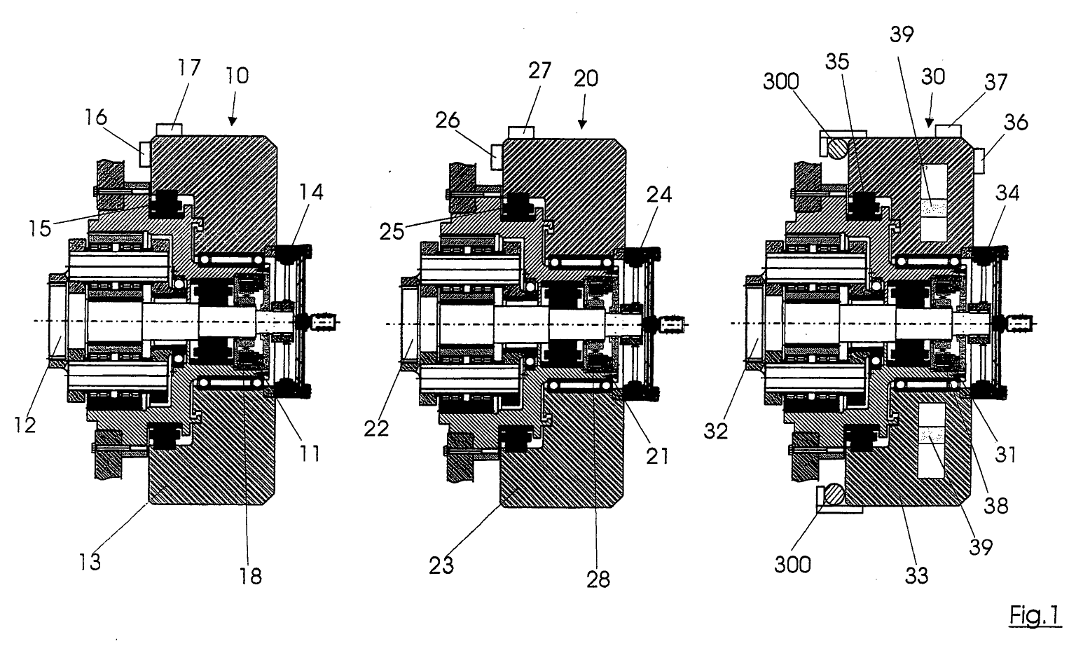

FIG. 1 illustrates driving units designated generally by numerals 10, 20 and 30 which are each part of respective generally known presses and therefore not shown here in detail. The presses are arranged behind one another as is also known so that a workpiece to be machined travels through them in a successive manner. The driving units 10, 20 and 30 are equipped with a shaft drive 11, 21 and 31 for driving a main shaft 12, 22 and 32. The main shafts 12, 22 and 32 act upon the drive of the press slide as well as upon additional accessory devices, such as ejectors, transfer devices, tongs boxes and automating devices. The driving units 10, 20 and 30 also have a flywheel 13, 23 and 33 which can be coupled via couplings 14, 24 and 34 to the respective main shafts 12, 22 and 32 when this is necessary because of an increased energy demand. Then the energy stored in the flywheels 12, 23 and 33 can be supplied to the main shafts 12, 22 and 32 in order to be able to drive the accessory devices in addition to the press slide.

When the energy stored in the flywheels 13, 23 and 33 has been supplied or is no longer needed, the flywheels 13, 23 and 33 can be uncoupled from the main shafts 12, 22 and 32 via the couplings 14, 24 and 34. After the forming has been concluded, the press slide moves back, in which case the press has to withdraw only relatively little energy from the power supply network for this operation, so that the energy available in the power supply network can also be used for accelerating the flywheels 13, 23 and 33 in order to charge the flywheels 13, 23 and 33 with new energy to be stored in the flywheels 13, 23 and 33.

The acceleration of the flywheels 13, 23, 33 takes place by way of a flywheel drive 15, 25 and 35 which is therefore independent of the shaft drive 11, 21, and 31. The flywheels 13, 23, 33 have a unit 16, 26 and 36 for monitoring the rotational speed and a device 17, 27 and 37 for monitoring the rotational acceleration, which is preferably constructed as a Ferraris sensor. The devices 16, 26 and 36 for monitoring the rotational speed and the devices 17, 27 and 37 for monitoring the rotational acceleration are used for synchronizing the flywheels 13, 23 and 33 with the shaft drives 11, 21 and 31.

Together with a timing device, the devices 16, 26 and 36 are used for monitoring the rotational speed and the devices 17, 27 and 37 are used for monitoring the rotational acceleration for analyzing and predicting the required energy. Thus, the devices 16, 26 and 36 for monitoring the rotational speed, the devices 17, 27 and 37 for monitoring the rotational acceleration, the analyzing device and the predicting device together form a self-learning unit. This self-learning unit can detect changes of target definitions at every press of the entire press arrangement, such as, for example, changes of the rotational speed of the flywheels 13, 23, 33, and can then set a new value for the target definition.

In addition, the main shaft 12, 22 and 32 has a known type of device for monitoring the rotational speed (not shown here in detail) so that, as required, the main shaft 12, 22 and 32 can be braked via a brake 18, 28 and 38 to a desired rotational speed. The brake 18, 28 and 38 can advantageously feed the not-required energy back into the power supply network, so that it makes sense to use the shaft drive 11, 21 and 31 simultaneously also as a brake 18, 28 and 38. The shaft drive 11, 21 and 31 and the brake 18, 28 and 38 can, however, also have a separate construction.

The flywheel 33 has displaceable flywheel masses 39 that can be displaced hydraulically and/or pneumatically and/or electrically. By the displacement of the flywheel masses 39, the rotational speed of the flywheel 33 can be changed without the requirement of withdrawing additional energy from the power supply network or dissipating energy stored in the flywheel. In this manner, as a result of the displacement of the flywheel masses 39, a synchronization of the flywheel 33 with the main shaft 32 can also be achieved.

Furthermore, the flywheel 33 has devices 300 for compensating an unbalanced mass of the flywheel 33. Because the driving units 10, 20 and 30 are part of a press arrangement consisting of individual presses, the driving units 10, 20 and 30 must also be mutually synchronized with respect to the pressing operation of the entire press arrangement. In one arrangement, the drive 10, for example, can assume the function of a master drive and the drives 20 and 30 can assume the functions of slave drives. The operating parameters of the master drive 10 are therefore used as reference values for the operating parameters of the slave drives 20 and 30, so that, with respect to the pressing operation of the entire press arrangement, the slave drives 20 and 30 run synchronously with the master drive 10.

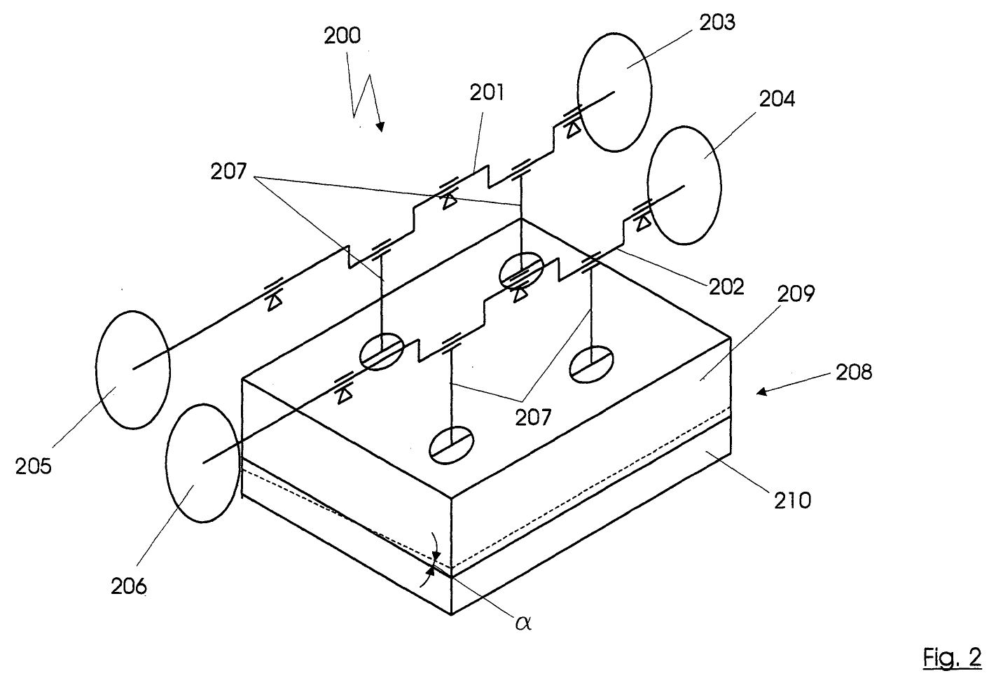

FIG. 2 schematically illustrates an eccentric press 200. The eccentric press 200 is equipped with crankshafts 201, 202 as main shafts. Shaft drives 203, 204 are situated at one end of the respective crankshafts 201, 202, and flywheels 205, 206 are situated at the other end. The crankshafts 201, 202 act by way slides 207 upon a tool 208. During the deep-drawing operation, it is important that an upper tool half 209 and a lower tool half 210 of the tool 208 are aligned parallel to one another along the tool length and along the tool width. When the parallelism of the two tool halves cannot be maintained, a synchronization error angle a occurs with respect to the tool parting plane between the two tool halves 209, 210. In order to maintain the parallelism of the two tool halves, and thus in order to exclude the synchronization error angle a, the two crankshafts 201, 202 must be mutually synchronized. For this purpose, the crankshafts 201, 202 can have known devices for monitoring the rotational speed.

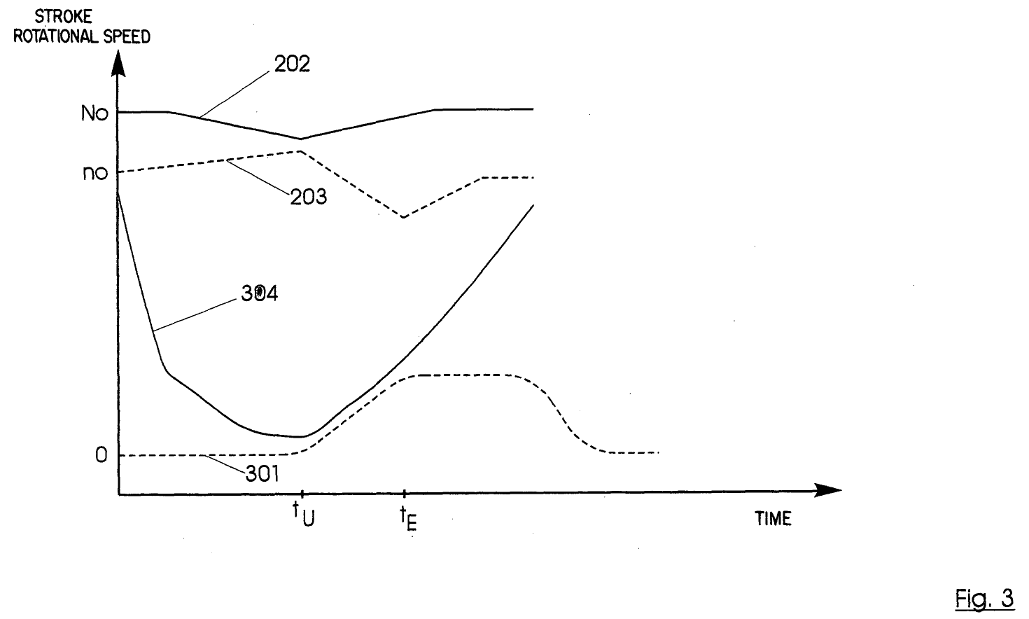

FIG. 3 illustrates the course 304 of the stroke of the press slide over time as a solid curve. The broken curve 301 indicates the course of the stroke of an ejector over time. As soon as the press slide has reached its lower reversal point at time tᵤ, the ejector starts its ejection stroke. Curves 304, 301 thus rise simultaneously from the point in time tᵤ to the point in time t_{E}. During the drawing operation, the rotational speed of the drive shaft of the press slide illustrated by curve 302 decreases to the point in time tᵤ, which, after the lower reversal point has been reached, is accelerated again to its initial rotational speed N₀.

The rotational speed of the drive shaft of the ejector, which is illustrated as a broken curve 303, increases to the point in time tᵤ. This increase can be achieved, for example, by a displacement of the flywheel masses 39. Starting at the point in time tᵤ, the ejector ejects the workpiece out of the tool, whereby the rotational speed of the drive shaft of the ejector decreases between the points in time tᵤ and t_{E}. After the workpiece has been ejected from the tool at time t_{E}, the stroke of the ejector does not change any more starting from the point in time t_{E}, as indicated in curve 301, until the ejector is moved back. Simultaneously, the rotational speed of the ejector drive increases again starting at time t_{E} until it has again reached the initial value n₀.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Press with a high pressure force characteristic, comprising at least one flywheel, and at least one shaft drive acting upon a shaft, wherein the at least one shaft drive and the at least one flywheel are mutually synchronized.

2. Press according to claim 1, wherein the at least one flywheel is connectable via the shaft with accessory devices of the press.

3. Press according to claim 1, wherein the at least one flywheel is selectively coupleable to and uncoupleable from the shaft.

4. Press according to claim 2, wherein the shaft further comprises a brake.

5. Press according to claim 4, wherein the at least one flywheel is selectively coupleable to and uncoupleable from the shaft.

6. Press according to claim 1, wherein the at least one shaft is a main shaft.

7. Press according to claim 1, wherein the at least one flywheel is arranged to be driven by a separate flywheel drive.

8. Press according to claim 1, wherein displaceable flywheel masses are operatively arranged in the at least one flywheel.

9. Press according to claim 8, wherein the displaceable flywheel masses are at least one of hydraulically, pneumatically and electrically displaceable.

10. Press according to claim 1, further comprising a device configured to monitor rotational speed of the at least one flywheel.

11. Press according to claim 1, further comprising a device configured to monitor rotational acceleration of the at least one flywheel.

12. Press according claim 1, further comprising a timing device.

13. Press according to claim 1, further comprising a device configured to analyze required energy.

14. Press according to claim 1, further comprising a device configured to predict required energy.

15. Press according to claim 14, further comprising a device configured to analyze required energy.

16. Press according to claim 15, wherein the analyzing device and the predicting device comprise a self-learning unit.

17. Press according to claim 1, further comprising a program connectable with the press for simulating a forming process.

18. Press according to claim 1, further comprising a device configured to supply at least one of a not-required energy quantity from one flywheel to another flywheel and to feed said not-required energy quantity back into the power supply network.

19. Press according to claim 1, wherein the at least one flywheel includes a device for compensating an unbalanced mass.

20. Press according to claim 1, wherein the at least one shaft drive has a device configured to monitor rotational speed.

21. Arrangement of several presses according to claim 1, wherein the at least one shaft drive of each press and the respective at least one flywheel of each press are mutually synchronized.
